(19) United States
(12) Patent Application Publication
(10) Pub. No.: US 2008/0191968 A1
(43) Pub. Date: Aug. 14, 2008

(54) ACTIVE MATRIX DISPLAY DEVICE

(76) Inventor: Kazuyoshi Kawabe, Yokohama (JP)

Correspondence Address: Frank Pincelli;Patent Legal Staff, Eastman Kodak Company, 343 State Street, Rochester, NY, 14650-2201, US

(21) Appl. No.: 12/017,471

(22) Filed: Jan. 22, 2008

(30) Foreign Application Priority Data
Feb. 9, 2007 (JP) 2007-31139

(51) Int. Cl. G09G 3/20

(52) U.S. Cl. 345/55

(57) ABSTRACT

Selection lines are formed using one type of transistor. A data driver supplies data to data lines provided in correspondence with pixel rows. A gate driver supplies selection signals via a first switch to gate lines provided in correspondence with pixel lines. Also, each gate line is connected via a second switch to an off power supply. Then, voltages of the gate lines are controlled by switching the first and second switches on in a complementary manner.

### CROSS-REFERENCE TO RELATED APPLICATION

This application claims priority of Japanese Patent Application No. 2007-31139 filed Feb. 9, 2007 which is incorporated herein by reference in its entirety.

### FIELD OF THE INVENTION

The present invention relates to an active matrix display device for performing display by supplying data to pixel elements arranged in a matrix shape.

### BACKGROUND OF THE INVENTION

Active matrix display devices are capable of being made high resolution, and so are becoming widespread as displays. Active matrix display devices currently require active elements in order to determine a display state one pixel at a time. Particularly in the case of a current drive device such as an organic EL display, drive transistors capable of supplying electrical current to the light-emitting elements are provided. A thin film transistor (TFT) formed from a thin film such as amorphous silicon or polysilicon is used as such a drive transistor, but it is difficult to achieve uniform characteristics in a ° FT.

A number of methods for correcting the characteristics of a TFT with circuit technology have been proposed, and one such method proposes digital driving (WO 2005/116971).

A circuit disclosed in the above described related art example is easily realized using a CMOS process. However, since the CMOS process requires formation of P-type and N-type transistors there are a lot of manufacturing steps and the substrate cost is high.

If a single type of transistor is used, it is possible to reduce the number of manufacturing steps. For example, if a PMOS process having a reduced number of manufacturing steps is used, it is possible to realize a lower cost substrate, but with a P-type transistor there is poor degree of freedom with respect to the circuitry, and implementing the functions disclosed in the related art example is difficult.

### SUMMARY OF THE INVENTION

The present invention provides an active matrix display device for performing display by providing data to pixels arranged in a matrix shape, comprising a data driver for supplying data to data lines providing in correspondence with pixel rows, and a selection driver for supplying sequential selection signals to selection lines provided in correspondence with pixel lines to control data acquisition from data lines corresponding to corresponding pixels, wherein the selection driver includes a shift register for receiving supply of a shift clock and transferring sequential selection signals to a multiple stage register, a first switch connected to register outputs of each stage of this shift register and controlling supply of selection signals to corresponding selection lines, and a maintenance driver connected to each selection line, and connecting that selection line to an off power supply to erase the selection line when the first switch of each selection line is turned off.

Also, the maintenance driver preferably has a second switch for controlling connection between each selection line and the offpower supply, and complementarily switches the first switch and the second switch on and off.

The first switch and the second switch are preferably formed with p channel transistors, and signals supplied to the first switch and the second switch connected to the same selection line are made signals of mutually opposite polarity.

In this way, according to the present invention, a selection signal is supplied to a selection line via a first switch, but it is possible to connect this selection line to an off power supply using a second switch. Accordingly, by controlling the first switch and the second switch, it is possible to reliably control the potential of the selection line to a specified potential. It is therefore also possible to make both the first switch and the second switch p-channel transistors.

### BRIEF DESCRIPTION OF THE DRAWINGS

FIG. 1 is the overall structure of a display structure including a gate driver of this embodiment;

FIG. 2 is a drawing showing sub-frame scan timing for digital drive;

FIG. 3 is a drawing showing drive timing of a gate driver of this embodiment;

FIG. 4A is an equivalent circuit of a pixel etc. in the case of a static memory being provided in a pixel; and

FIG. 4B is a pixel circuit diagram looking from an opposite side to a light emitting surface when a static memory is provided in a pixel.

### DESCRIPTION OF THE PREFERRED EMBODIMENTS

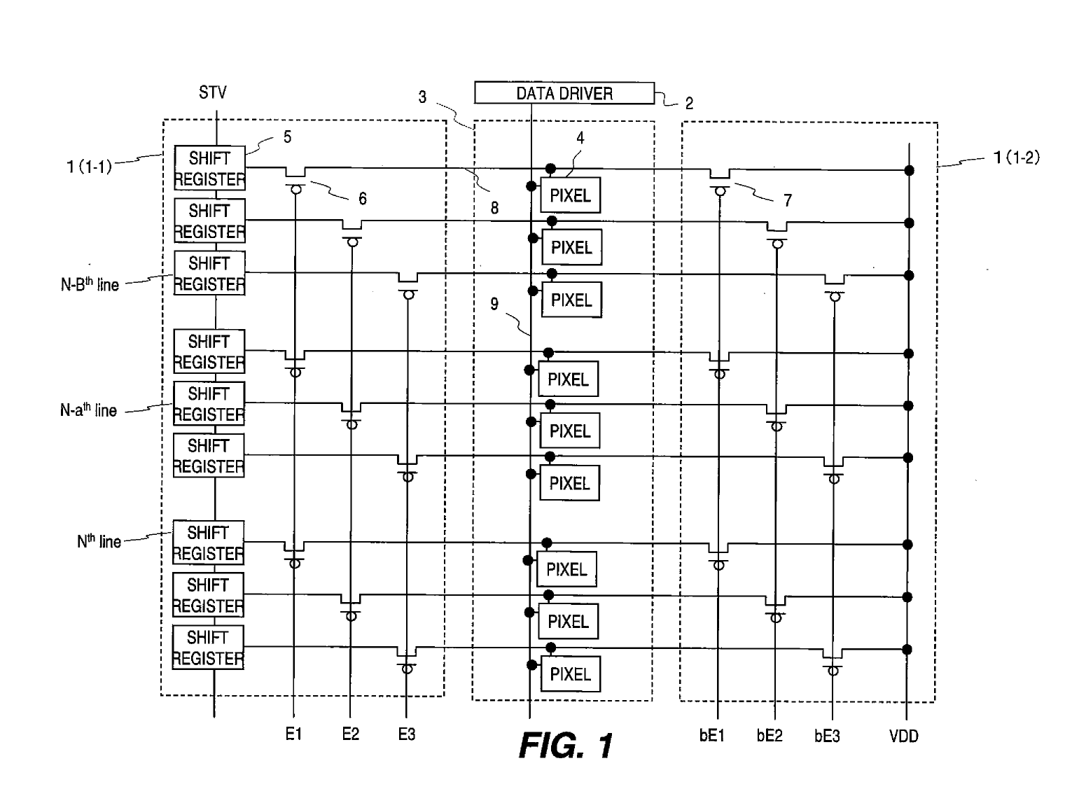

Embodiments of the present invention will be described in detail in the following using the drawings. An example of a display device including a gate driver 1 of the present invention is shown in FIG. 1.

The display device of FIG. 1 has a gate driver (selection driver) 1 that is functionally divided into a control section 1-1 for controlling selection and non-selection of a gate line (selection line) 8, and a maintenance section 1-2 for maintaining non-selection of the gate line 8, a data driver 2 for supplying a data signal corresponding to image data from outside to a data line 9, and a pixel array 3 having pixels 4 arranged in a matrix shape in the row direction and line direction.

In FIG. 1, the gate driver 1 is divided in to a control section 1-1 and a maintenance section 1-2, for the sake of convenience of the structure of the display device, but they can both be integrated to configure a gate driver 1.

The gate driver control section 1-1 has a shift register 5 for sequentially transferring a selection signal STV in a vertical direction in accordance with a shift clock. Outputs of each stage of the shift register 5 are connected via first switches 6 to gate lines 8 of the corresponding line. The first switch 6 is formed of P-type transistors, with gate terminals of the transistors being connected to the same control line for every three lines. Specifically, gate terminals of the first switches 6 of the 1^{st}, 4^{th}, 7^{th}, 3×(n+1)^{th} lines are connected to control line E1, gate terminals of first switches 6 of the 2^{nd}, 5^{th}, 8^{th} 3×(n+2)^{th} lines are connected to the control line E2, and the gate terminals of the first switches 6 of the 3^{rd}, 6^{th}, 9^{th}, (3×n)^{th} lines are connected to control line E3. n is a positive integer.

On the other hand, the gate driver maintenance section 1-2 has second switches 7 for connecting the gate lines 8 to a power supply line at the off level (for example VDD) provided for each line. The second switch 7 is also formed of P-type transistors, with gate terminals of the transistors being connected to the same control line every three lines. Specifically, gate terminals of the second switches 7 of the 1^{st}, 4^{th}, 7^{th}, 3×(n+1)^{th} lines are connected to control line bE1, gate terminals of second switches 7 of the 2^{nd}, 5^{th}, 8^{th} 3×(n+2)^{th} lines are connected to the control line bE2, and the gate terminals of the first switches 6 of the 3^{rd}, 6^{th}, 9^{th}, 3×n^{th} lines are connected to control line bE3.

Mutually opposite polarity selection pulses are respectively applied to the control lines E1 and bE1, E2 and bE2, and E3 and bE3. Therefore, the selection state does not become indefinite as a result of turning the first switch 6 and the second switch 7 on at the same time so that the gate line 8 is simultaneously driven by the gate driver control section 1-1 and the gate driver maintenance section 1-2. That is, the gate line 8 is connected to either the gate driver control section 1-1 or the maintenance section 1-2.

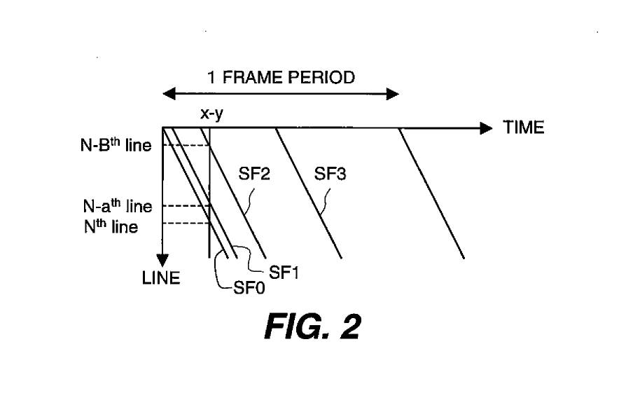

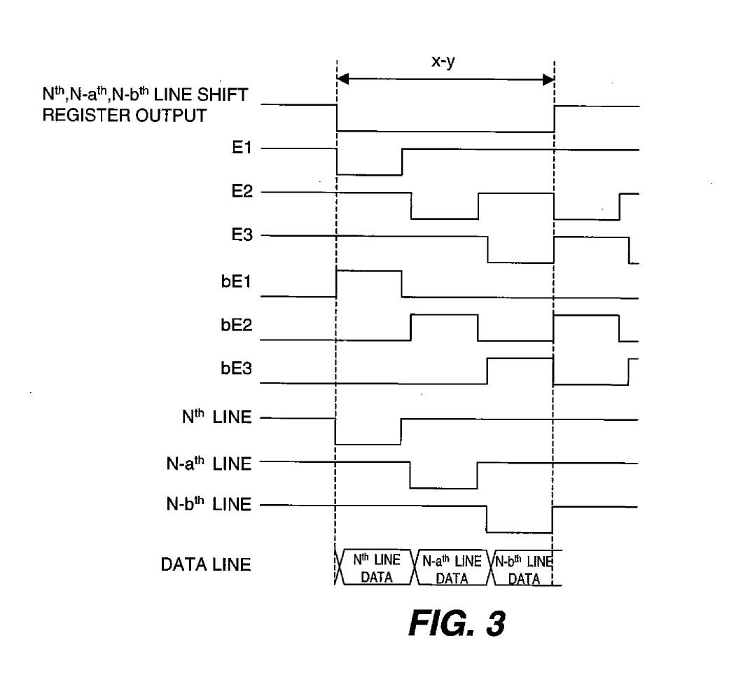

Next, a method of implementing digital drive using the gate driver 1 will be described. As an example, a case of performing digital drive for a 4-sub-frame (SF) structure capable of realizing 4-bit gradation (16 shades) as shown in FIG. 2 will be considered.

Sub-frames SF0-SF3 are set so that their respective light emitting periods are in a ratio of approximately SF0:SF1:SF2:SF3=1:2:4:8. SF0 is about 1/15 of one frame period, and so as shown in FIG. 2 SF1 commences almost immediately after commencement of display of SF0. If this procedure is followed, if attention is paid to the line selected in the period x-y, which is a one frame period, it is necessary to select the N^{th}, N-a^{th} and N-b^{th} lines at the same time. If these lines are actually selected at the same time the same data will be written, and so it is necessary to offset the times, that is, perform time divided selection.

This time divided selection can be implemented using the gate driver 1, by making remainders after dividing the values of N, N-a and N-b by 3 mutually different. For example, if the design is such that when N is “100” N-a becomes “92” and N-b becomes “72”, then when respectively dividing by 3 the remainder for N will be 1, for N-a will be 2 and for N-b will be 0, and it is possible to carry out control with the respectively different control lines E1, E2 and E3. Also, since an interval between line N line and line N-a (8 lines) and an interval between N-a and N-b (20 lines) satisfy a relationship of roughly 1:2, a relationship between sub-frames SF0 and SF1 is also kept the same, which shows that desired digital drive is implemented.

If selection signals and a shift clock (not shown in the drawings) are appropriately input to the data input STV and the clock input respectively of the shift register 5, selection signal are stored in shift registers for the N^{th}, N-a^{th} and N-b^{th} lines in period x-y. First of all, if the control line E1 is selected, the gate terminal of the first switch 6 of the Nth line is connected to the control line E1, and so the selection signal for the shift register 5 is reflected to the gate line 8 and the N^{th} line is selected. As will be understood, the gate lines 8 of 1^{st}, 4^{th}, 7^{th}, 3*n+1^{th} lines that are connected to the control line similarly to the N^{th} line are also connected to outputs of the shift registers 5, but since selection signals are not stored for other than the N^{th} line the gate lines 8 of the 1^{st}, 4^{th}, 7^{th}, 3*n+1^{th} lines are not selected.

If the data driver 2 outputs bit data of the N^{th} line to the data line 9 at this timing, desired data is written to only the N^{th} line. If data writing is completed and the first switch 6 of the N^{th} line is turned of by a selection pulse for the control line E1, the gate line 8 of the N^{th} line is put in a floating state, but since an opposite phase selection pulse is input to the control line bE1 the second switch 7 of the N^{th} line is immediately turned on, and the gate line 8 is connected to the off level power supply (for example power supply VDD), the gate line 8 of the N^{th} line is placed in a non-selected state.

Similarly, the N-a^{th} and N-b^{th} lines select only the gate lines 8 of the N-a^{th} and N-b^{th} lines using the respective control lines E2 and E3, and by supplying data in synchronism with this desired data is also written to the N-a^{th} line and the N-b^{th} line. If writing is completed, selection pulses of opposite phase to the control lines E2 and E3 are input to the control line bE2 and bE3, which indicates that gate lines 8 of those control lines are connected to the off level power supply by the second switches 7, and placed in a non-selected state.

If the clock is input to the shift registers 5, the selection signal is transferred to the next line, but if at that time the control line E1 is rewritten to E2, control line E2 rewritten to E3, and E3 rewritten to E1, it is possible to understand that similar control is possible.

In this way, if the gate driver of this embodiment is adopted in digital drive, it is possible to implement all circuits using P-type transistors. It is therefore possible to realize lowered cost of the display device. With the present invention, P-type transistors have been used, but similar functions can also be realized using N-type transistors formed of amorphous silicon etc.

Also, if a static memory is provided in each pixel 4, data written at one time is statically maintained, and so it is not necessary to continuously input pulses to the shift register. At this time, if a direct current non-selection signal is input to the control lines E1, E2 and E3, then outputs of shift registers 5 of all lines, and the gate lines 8, are isolated by the first switches 6, and since the gate lines 8 of all lines are connected to the off level power supply by the second switches 7 using the control lines bE1, bE2 and bE3 to which selection signals of opposite phase are input, off states are maintained. It is possible to input selection signals and clocks to the shift registers 5 and supply selection pulses to the control lines E1-3 and bE1-bE3 only when there is a need to update, which shows that drive is possible with reduced power consumption.

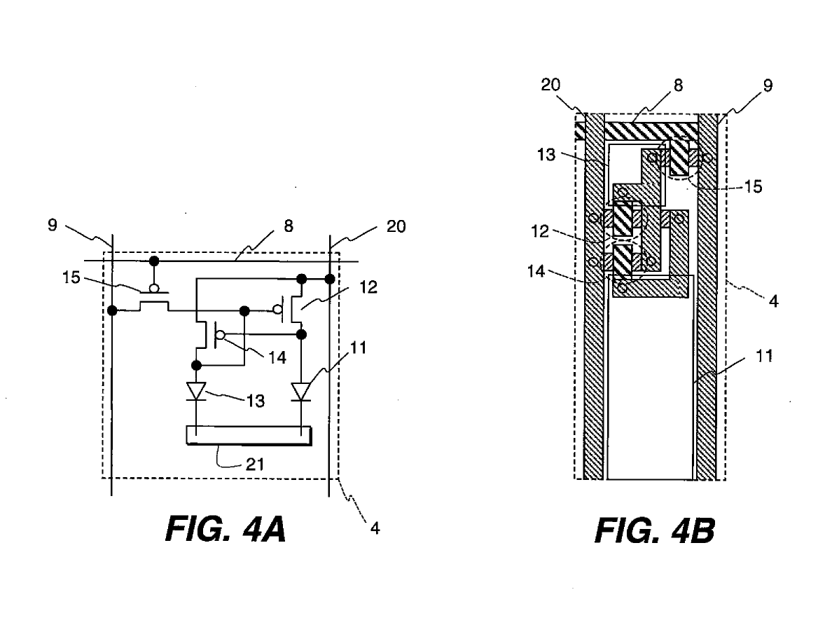

FIG. 4A and FIG. 4B show an equivalent circuit for a pixel etc. in the case of a static memory being provided in the pixel, and a pixel circuit diagram looking from an opposite side to a light emitting surface.

The pixel circuit 4 of FIG. 4A and FIG. 4B includes a first organic EL element 11 for contributing to light emission, a first drive transistor 12 for driving the first organic EL element 11, a second organic EL element 13 that does not contribute to light emission, a second drive transistor 14 for driving the second organic EL element 13, and a gate transistor 1S. An anode of the first organic EL element 11 is connected to a drain terminal of the first drive transistor 12 and the gate terminal of the second drive transistor 14. Also, a gate terminal of the first drive transistor 12 is connected to the anode of the second organic EL element 13, the drain terminal of the second drive transistor 14, and the source terminal of the gate transistor 15. Further, the gate terminal of the gate transistor 15 is connected to the gate line 8, and the drain terminal of the gate transistor 15 is connected to the data line 9. Source terminals of the first drive transistor 12 and the second drive transistor 14 are connected to a power supply line 20, while the cathodes of the first organic EL element 11 and the second organic EL element 13 are connected to an electrode 21.

If a selection signal (Low) is supplied to the gate line, the gate transistor 15 is turned on, and a data voltage of the data line 9 is supplied to the gate terminal of the first drive transistor 12 the anode of the second organic EL element 13, and the drain terminal of the second drive transistor 14.

The data voltage being supplied on the data line is Low, the gate voltage of the first drive transistor 12 becomes Low, and the first drive transistor 12 is turned on. If the first drive transistor 12 is turned on, the anode of the first organic EL element 11 is connected to the power supply 20 being supplied with the power supply voltage VDD, and current flows in the first organic EL element 11 to emit light. At the same time as this, the gate terminal of the second drive transistor 14 also becomes VDD, the second drive transistor 14 is turned off, and as a result the anode of the second organic EL element 13 is lowered to close to the cathode potential VSS.

This voltage close to the cathode potential is supplied to the gate terminal of the first drive transistor 12, which shows that even after the gate line 8 has gone High and the gate transistor 15 has been turned off, the written Low data is maintained while VDD and VSS are present.

If the data voltage is High, the second drive transistor 14 is turned on while the first drive transistor 12 is turned off, and electrical current flows in the second organic EL element 13, but this second organic EL element 13 is shielded and so there is no light emission. It is also possible to provide a switch transistor instead of the second organic EL element 13 and connect a gate terminal of this switch transistor to the gate of the first drive transistor, and when the first drive transistor is off it will turn this switch transistor off.

The invention has been described in detail with particular reference to certain preferred embodiments thereof, but it will be understood that variations and modifications can be effected within the spirit and scope of the invention.

### PARTS LIST

1 gate driver (selection driver)
1-1 control section
1-2 maintenance section
2 data driver
3 pixel array
4 pixels
5 shift register
6 switches
7 switches
8 gate line (selection line)
9 data line
11 organic EL element
12 drive transistor
13 organic EL element
14 drive transistor
15 gate transistor

1. An active matrix display device for performing display by supplying data to pixel elements arranged in a matrix shape, comprising:
a data driver for supplying data to data lines provided in correspondence with pixel rows; and
a selection driver for supplying sequential selection signals to selection lines provided in correspondence with pixel lines to control data acquisition from data lines corresponding to corresponding pixels, wherein:
the selection driver comprises:
a shift register for receiving supply of a shift clock and transferring sequential selection signals to a multiple stage register;
a first switch connected to register outputs of each stage of this shift register, and controlling supply of selection signals to corresponding selection lines; and
a second switch, connected to each selection line, and connecting that selection line to an off power supply to erase the selection line when the first switch of each selection line is turned off.

2. The active matrix display device of claim 1, wherein:
the first switch and the second switch are turned on and off in a complementary manner.

3. The active matrix display device of claim 1, wherein:
the first switch and the second switch are formed with p channel transistors, and signals supplied to the first switch and the second switch connected to the same selection line are made signals of mutually opposite polarity.
